(19) United States
(12) Patent Application Publication
(10) Pub. No.: US 2014/0095257 A1
(43) Pub. Date: Apr. 3, 2014

(54) ANALYZING USER ACTIONS IN A SOCIAL GRAPH

(71) Applicant: GOOGLE INC., Mountain View, CA (US)

(72) Inventors: Justin LEWIS, Marina del Rey, CA (US); Michael Patrick SCHNEIDER, Venice, CA (US)

(73) Assignee: GOOGLE INC., Mountain View, CA (US)

(21) Appl. No.: 13/972,810

(22) Filed: Aug. 21, 2013

Related U.S. Application Data
(60) Provisional application No. 61/707,837, filed on Sep. 28, 2012.

(51) Int. Cl. G06Q 30/02; G06Q 50/00

(52) U.S. Cl. CPC G06Q 30/0202; G06Q 50/01
USPC 705/7.31; 705/7.33

(57) ABSTRACT

A method includes collecting user interaction data for one or more users in an extended social network, clustering each of the one or more users into one or more groups of users based on the collected user interaction data for each user, wherein each of the one or more users is clustered into no more than one group of the one or more groups of users, monitoring, over a time period, a change in a size of each group of users at one or more increments of the time period and generating observation information for each group of users during each of the one or more increments of the time period, wherein the observation information is based on the monitored change in size of each group of users.

### CROSS-REFERENCE TO RELATED APPLICATIONS

The present application claims the benefit of priority under 35 U.S.C. §119 from U.S. Provisional Patent Application Ser. No. 61/707,837, filed on Sep. 28, 2012, the disclosure of which is hereby incorporated by reference in its entirety for all purposes.

### BACKGROUND

Understanding trends that are happening in groups over periods of time allows content providers to better serve their consumers.

### SUMMARY

The subject disclosure relates generally to analyzing trends, and more particularly to analyzing trends in an extended social network.

The subject disclosure relates to a machine-implemented method that includes collecting user interaction data for one or more users in an extended social network, wherein the extended social network comprises interaction data between each of the one or more users and one or more entities, clustering each of the one or more users into one or more groups of users based on the collected user interaction data for each user, wherein each of the one or more users is clustered into no more than one group of the one or more groups of users, monitoring, over a time period, a change in a size of each group of users at one or more increments of the time period and generating observation information for each group of users during each of the one or more increments of the time period, wherein the observation information is based on the monitored change in size of each group of users.

These and other aspects may include one or more of the following features. The method may further include plotting observation information for each group of users on a graph according to the change in size of each group of users during each increment of the time period. Observation information for each group of users may be generated in relation to a pre-defined condition. The generated observation information may further be associated with the predefined condition. The predefined condition may be supplied by a third party.

A duration of the time period may be predetermined. A frequency of the one or more increments of the time period may also be predetermined. Monitoring a change in a size of each group of users at each of the one or more increments of the time period may include monitoring a rate of the change in the size of each group of users at each of the one or more increments of time.

The present disclosure also relates to a system that includes a data collection module configured to collect user interaction data for each user in an extended social network, wherein the extended social network comprises interaction data between each user and one or more entities, a clustering module configured to cluster each user into one or more groups of users based on the collected user interaction data for each user, wherein each user is clustered into no more than one group of the one or more groups of users, a monitoring module, configured to monitor, over a time period, a change in a size of each group of users at one or more increments of the time period and an observation module configured to generate observation information for each group of users during each of the one or more increments of the time period, wherein the observation information is based on the monitored change in size of each group of users.

The system may also include a plotting module, configured to plot observation information for each group of users on a graph according to the change in size of each group of users during each increment of the time period. The observation information for each group of users may be generated in relation to a predefined condition. The generated observation information may further be associated with the predefined condition, which may be supplied by a third party. A duration of the time period may be predetermined and a frequency of the one or more increments of the time period may also be predetermined.

The present disclosure furthermore relates to a machine-readable medium comprising instructions stored therein, which when executed by the processors, cause the processors to perform operations that include collecting user interaction data for one or more users in an extended social network, wherein the extended social network comprises interaction data between each of the one or more users and one or more entities, clustering each of the one or more users into one or more groups of users based on the collected user interaction data for each user and monitoring, over a time period, behavior trends for each group of users at one or more increments of the time period. The operations also include generating, in relation to a pre-defined condition, observation information for each group of users during each of the one or more increments of the time period, wherein the observation information is based on the monitored behavior trends for each group of users and associating the generated observation information with the pre-defined condition.

The operations may further include plotting observation information for each group of users on a graph according to the change in size of each group of users during each increment of the time period. The pre-defined condition may be supplied by a third party. A duration of the time period may be predetermined. Also, a frequency of the one or more increments of the time period may be predetermined. Each of the one or more users may be clustered into no more than one group of the one or more groups of users. Monitoring, over a time period, behavior trends for each group of users at each pre-determined increment of the time period may include monitoring a change in a size of each group of users. Generating, in relation to a pre-defined condition, observation information for each group of users during each pre-determined increment of the time period may include generating observation information that is based on the monitored change in the size of each group of users.

These and other aspects may provide one or more of the following advantages. Social networks can increase user engagement by making better content recommendations for users, gaining a better understanding of which topics are trending and should be promoted or highlighted at the social network, and gaining a better ability to match advertising to users by better understanding the users' interests.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an example system for analyzing trends in user actions in an extended social network.

FIG. 2 illustrates a flow diagram of an example process for analyzing trends in user actions in an extended social network.

FIGS. 3A and 3B conceptually illustrate diagrams of a graph showing a change in size of a group of users according to an aspect of the subject technology.

FIG. 4 conceptually illustrates an example of a system for analyzing trends in user actions in an extended social network.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Social networks contain large amounts of information about their users. Such information is often in the form of user actions such as posts, affirmations of content (e.g., “+1” or “Like”), comments on third party posts, messages, sharing content, etc. The actions of the users represent the users' interests, as well as the trends that are happening in various groups within a social network. Understanding trends that are happening in groups over periods of time allows content providers to better serve their consumers. However, due to the large volume and complexity of the data at a social network, understanding trends that are happening within a social network across various groups of users over a period of time is difficult.

Methods and systems for analyzing user actions in an extended social network are provided herein. A social network consists of users and links between the users. A social network can be augmented with data beyond just users and links between them. A social network can include entities such as organizations, web pages, documents and events, and the links from users to those entities. The links may capture such interactions as attendance at a party, affirmations of content, membership in a group, etc. Such network structure is referred to herein as an “extended social network.” The disclosed subject matter provides a method for analyzing and visualizing the changing structure of an extended social network over time.

Extended social network information is captured regularly, for example, every day. The extended social network information is clustered according to various conditions, at each time interval. The clustering conditions link users in the extended social network based on common actions at the social network. For example, the users interact with other users on a given topic; therefore they may be clustered together in a cluster formed around the given topic. Each user or entity is assigned to a cluster and the cluster is followed over a period of time. The size of the cluster at each point or increment of time, during the period of time, is monitored by the system. The accumulated cluster information may be presented in the form of a graph, for visual analysis. From the graph, the growth and the rate of change of a particular cluster can be observed.

In operation, an entity such as, for example, a car company, may use a graph that represents the change in the size of a particular cluster, to analyze response to an ad campaign that the car company runs at a social network. Clusters may be formed from the users who are connected to the car company. For example, the relevant users may be those who visited the social network page of the car company, follow the company's news, subscribe to the company's feeds, discuss the car company with other users, etc. Clusters of users may be formed based on certain conditions in which the car company is interested. For example, the clustering algorithm may separate users into different user groups. There may be a group for users who are: a) parents and own a car from the car company, b) truck owners, c) sports car owners, d) people interested in historical cars, and e) international visitors to the car company's page at the social network. As stated previously, users are clustered into groups based on their interactions at the social network. The interactions form a basis for determining to which cluster a user may belong. While the users in each group may not be exactly the same, from day to day, there is significant overlap. A minimum percentage of overlap may be established which allows two groups on two different days to be identified as the same group or as representing the same group.

Each group of users is followed over a period of time. For each group, information on the change in the size of the group at each time increment over the period of time is monitored. Each group's behavior may be plotted on a graph or another visual representation for the group's activity. Each group of users may be compared to other groups, over time.

By way of example if the car company released an ad campaign about a new truck on a an arbitrary day X, the car company may wish to have each group's behavior relating to the ad campaign monitored over the calendar month following day X. The car company may, therefore, determine that a certain group, for example, group “b) truck owners,” responds well to the campaign, as may be evidenced by increased or positive interaction of that group of users with the car company's site after the release of the ad campaign, while another group of users may be neutral or exhibit a negative interaction response. The car company may, therefore, observe that its ad campaign is a success because it has reached the target audience—cluster “b” which includes truck owners. The company may know this because the size of that user group has increased since the beginning of the ad campaign. Alternatively, if the goal of the ad campaign was to entice users who previously were not interested in trucks, the car company may conclude that the ad campaign was not effective, because the number of users who interacted with the ad campaign from those groups declined and the size of that user group has decreased since the beginning of the ad campaign.

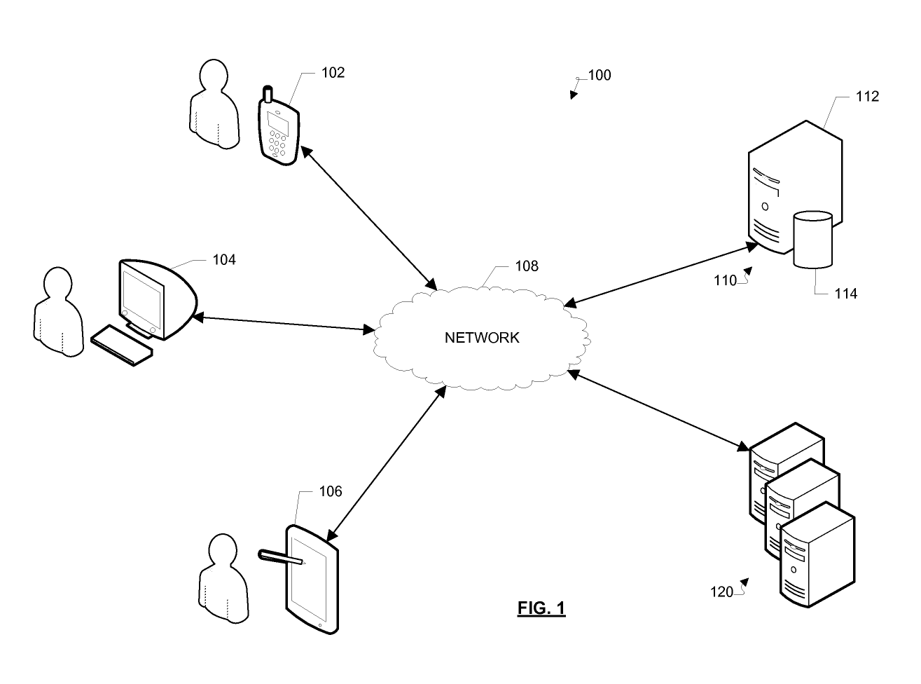

FIG. 1 illustrates an example client-server network that provides for analyzing trends in user actions in an extended social network. A network display 100 includes a number of electronic devices 102, 104 and 106 communicably connected to a server 110 by a network 108. Server 110 includes a processing device 112 and a data store 114. Processing device 112 executes computer instructions stored in data store 114, for example, instructions to collect user interaction data, to cluster users into one or more groups, to monitor groups of users and to generate observation information for each group of users.

Data store 114 may store information pertaining to, for example, collected user interaction data and observation information for each group of users. Servers 110 or application servers 120 may host an application within which some of the processes discussed herein are implemented. In some example aspects, electronic devices or client devices, as used interchangeably herein, 102, 104 and 106 can be computing devices such as smartphones, PDAs, portable media players, tablet computers, televisions or other displays with one or more processors coupled thereto or embedded therein, or other appropriate computing devices that can be used for running a mobile application.

Electronic devices 102-106 may have one or more processors embedded therein or attached thereto, or other appropriate computing devices that can be used for accessing a host, such as server 110. In the example of FIG. 1, electronic device 102 is depicted as a smartphone, electronic device 104 is depicted as a tablet computer, and electronic device 106 is depicted as a PDA. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110), collects user interaction data for one or more users in an extended social network. The users may interact with the system with any of the electronic device 102-106, wherein the extended social network comprises interaction data between each of the one or more users and one or more entities. The users are clustered into one or more groups of users based on the collected user interaction data for each user by the application servers 120 or server 110. Each of the one or more users is clustered into no more than one group of the one or more groups of users. Data pertaining to which cluster a user belongs to or whether a particular user belongs to any cluster may be stored in data store 114. Application servers 120 may also monitor, over a time period, a change in a size of each group of users at one or more increments of the time period and generate observation information for each group of users during each of the one or more increments of the time period. The observation information is based on the monitored change in size of each group of users.

Application servers 120 are in communication with the electronic devices 102-106 through network 108. Each electronic device 102-106 may be a client device or a host device. In some example aspects, server 110 can be a single computing device such as a computer server. In other implementations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

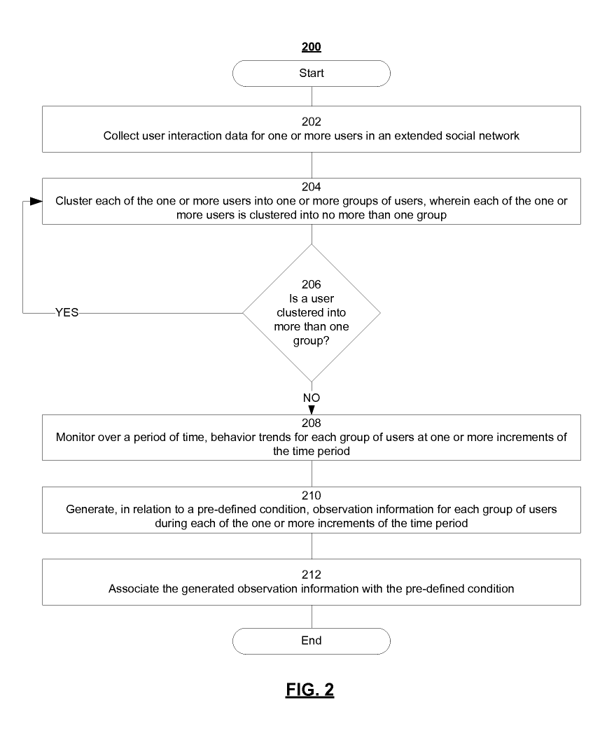

FIG. 2 illustrates a flow diagram of an example process 200 for analyzing trends in user actions in an extended social network. Process 200 begins and at block 202, the system collects user interaction data for one or more users in an extended social network. The user interaction data may be based on one or more actions such as submitting posts, affirming content (e.g., “+1” or “Like”), commenting on third party posts, messaging, sharing content, etc. The interaction data represents the users' interests, as well as the trends that are happening in various groups within a social network.

At block 204, the system clusters each of the one or more users into groups of users. Each of the one or more users, however, is clustered into no more than one group. The users are clustered based on the collected user interaction data for each user. Furthermore, the users may be clustered based on actions that are common among the users. That is, when the system cluster the users into groups, the system identifies or infers commonalities between the users, such as common interests or actions.

The users may be clustered into groups on a daily basis and, the users are expected to fall into the same group, from day to day. Some variation or deviation may be allowed, however, most users belong to the same group, day after day. When there are variations as to which group a particular user belongs to, the system may further determine which group the user belongs to, the most.

The system may identify a given clustered group as the same group, from day to day by, for example, establishing minimum overlap requirements. For example, if 50% of users within a given group appear in the same group from day to day, the system determines that it is the same group. When, however, there is only 10% of users appearing in the same group, the system may determine that the users may have been clustered into a new group.

Clustering users may be implemented with hierarchical network clustering. In hierarchical clustering, a weight W(i,j) is assigned to each pair of vertices (i,j) in the network. The weight may be chosen arbitrarily to represent a relationship between two entities. Then, in the agglomerative form of hierarchical clustering, each vertex is in its own cluster. Each vertex is added successively into the network, from the highest weight to the lowest. Vertices which can reach each other are considered part of a cluster. Eventually all of the edges are added into the network, which at the final step results in one cluster. Thus, a dendrogram, or tree diagram, is formed. At each step in the dendrogram, there are a set of clusters, starting with each vertex in its own cluster and ending with all vertices in one cluster.

The system determines where to slice the dendrogram to determine the final set of clusters. One method is to use the median step in the dendrogram. Another is to compute the modularity of the dendrogram at each step. Modularity “Q” may defined as follows: “eᵢⱼ” is the fraction of edges in the network that connect vertices in the group to those in group “i” to group “j;” and

$${a}_{i} = {\sum }_{j} {e}_{ij} .$$

### Then

$$Q = {\sum }_{i} ( {e}_{ii} - {a}_{i}^{2} ) .$$

. The horizontal slice of the dendrogram is selected based on selecting the slice which maximizes “Q.” Such metric computes the fraction of edges that fall within communities, minus the expected value of the same quantity if edges fall at random without regard for the community structure.

At block 206, the system confirm that each user is clustered into no more than one group. As stated previously, when a particular user belongs to more than one group, the system identifies, based on the user's actions, interactions and the weights associated with each action or interaction, which group the particular user belongs to the most.

At block 208, the system monitors, over a period of time, behavior trends for each group of users at one or more increments of the time period. That is, the system monitors what each group is doing and how it may be changing. The system may look at whether the group is increasing or decreasing in size, whether activity in the group is up or down, etc. A frequency of the one or more increments of the time period may be predetermined. That is, the increments may be daily, throughout the time period, or every other day throughout the time period. The duration of the time period may, likewise, be predetermined.

At block 210, the system generates observation information for each group of users during each increment of the time period. The observation information may summarize or interpret the behavior trends monitored at step 208. The observation information may be a full, unfiltered record of the behavior trends of the group. Alternatively, the observation information for a group of users may be generated in relation to a condition. Any condition may be implemented. For example, a condition may be to generate observation information that pertains to a certain company or a certain type of action or interaction. The condition may be defined or supplied by a third party, such as an entity interested in the observation information.

At block 212 the system associates the generated observation information with the predefined condition. That is, a correlation between the observation information and a condition may be deducted, from the observation information and the condition. Furthermore, the system may plot observation information for each group of users on a graph. The observation information may be plotted on a graph according to the change in size of each group of users during each increment of the time period. The graph illustrates the change in the size of each group as well as a rate of the change in size.

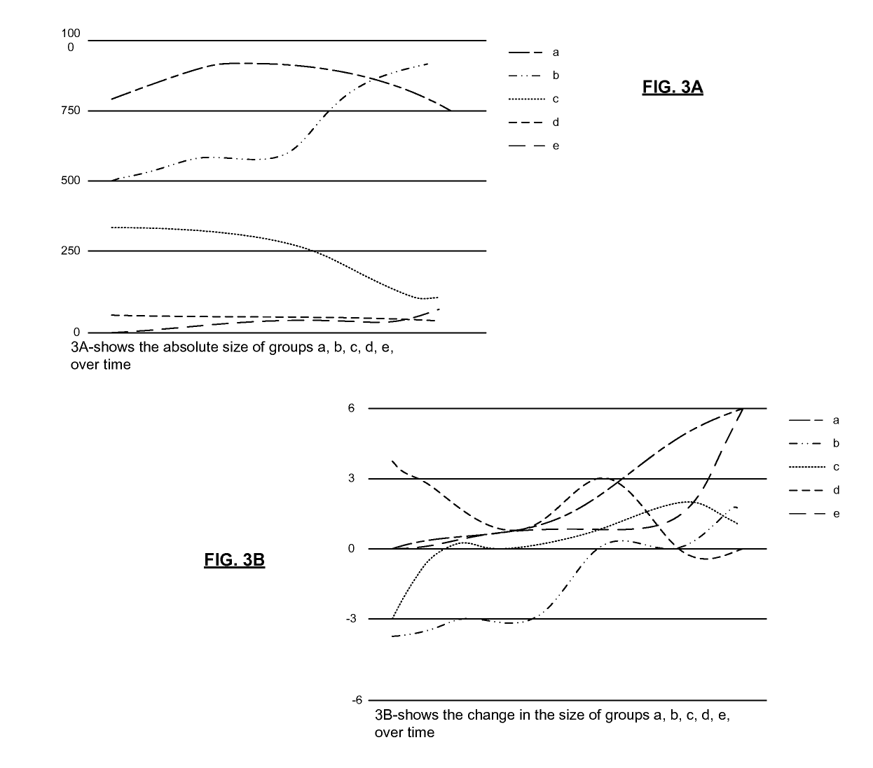

FIGS. 3A and 3B conceptually illustrate diagrams of a graph showing a change in size of a group of users according to an aspect of the subject technology. Specifically, FIG. 3A illustrates the absolute size of groups a, b, c, d, and e, based on observation information generated based on behavior trends monitored over a time period, as discussed in detail with reference to FIG. 2. FIG. 3B shows the change in the sizes of the groups a, b, c, d, and e, over time. Such graphs are useful to entities interested in understanding the actions of the various groups of users, over time. In one aspect, the graphs may be a visual representation of user engagement at a social network, over time. The behavior of the various groups of users may be monitored to determine how the groups react to certain events. One aspect of such information is the size of the group at various points throughout a time period.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

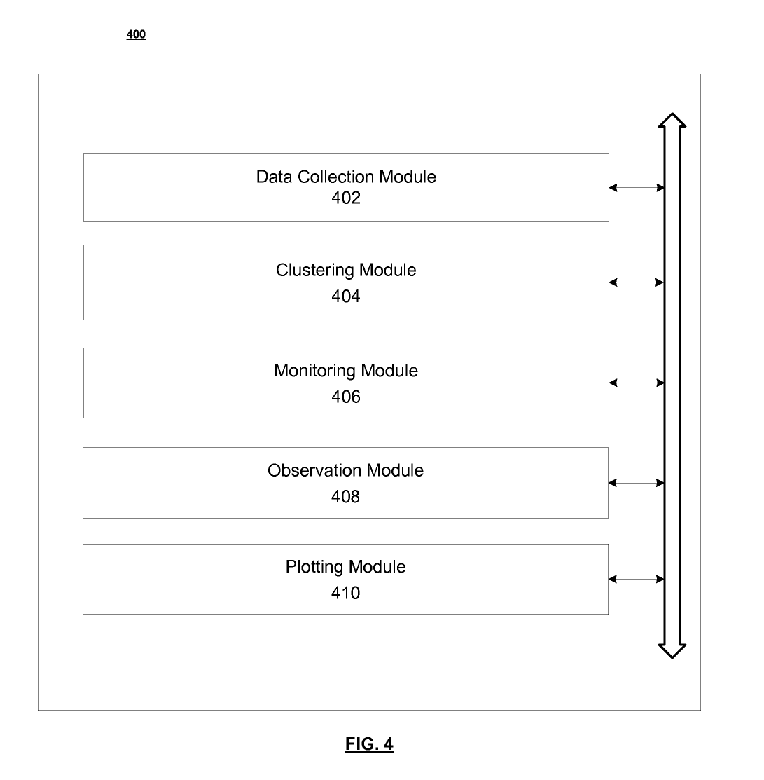

FIG. 4 illustrates an example of system 400 for automatically analyzing trends in user actions in an extended social network, in accordance with various aspects of the subject technology. System 400 comprises a data collection module 402, a clustering module 404, a monitoring module 406, an observations module 408, and a plotting module 410.

The data collection module 402 is configured to collect user interaction data for each user in an extended social network, wherein the extended social network comprises interaction data between each user and one or more entities. The clustering module 404 is configured to cluster each user into one or more groups of users based on the collected user interaction data for each user, wherein each user is clustered into no more than one group of the one or more groups of users. The monitoring module 406 is configured to monitor, over a time period, a change in a size of each group of users at each pre-determined increment of the time period. The observation module 408 is configured to generate observation information for each group of users during each pre-determined increment of the time period, wherein the observation information is based on the monitored change in size of each group of users. The plotting module 410 is configured to plot observation information for each group of users on a graph according to the change in size of each group of users during each increment of the time period.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

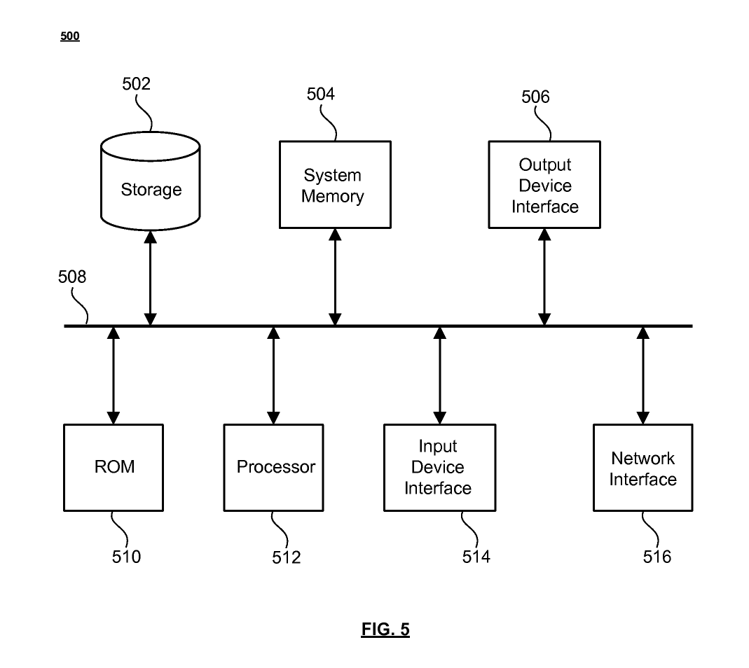

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method comprising:
collecting user interaction data for one or more users in an extended social network, wherein the extended social network comprises interaction data between each of the one or more users and one or more entities;
clustering each of the one or more users into one or more groups of users based on the collected user interaction data for each user, wherein each of the one or more users is clustered into no more than one group of the one or more groups of users;
monitoring, over a time period, a change in a size of each group of users at one or more increments of the time period; and
generating observation information for each group of users during each of the one or more increments of the time period, wherein the observation information is based on the monitored change in size of each group of users.

2. The computer-implemented method of claim 1, further comprising:
plotting observation information for each group of users on a graph according to the change in size of each group of users during each increment of the time period.

3. The computer-implemented method of claim 1, wherein observation information for each group of users is generated in relation to a pre-defined condition.

4. The computer-implemented method of claim 3, further comprising:
associating the generated observation information with the predefined condition.

5. The computer-implemented method of claim 3, wherein the predefined condition is supplied by a third party.

6. The computer-implemented method of claim 1, wherein a duration of the time period is predetermined.

7. The computer-implemented method of claim 1, wherein monitoring, over a time period, a change in a size of each group of users at each of the one or more increments of the time period comprises monitoring a rate of the change in the size of each group of users at each of the one or more increments of time.

8. The computer-implemented method of claim 1, wherein a frequency of the one or more increments of the time period is predetermined.

9. A system comprising:
a data collection module configured to collect user interaction data for each user in an extended social network, wherein the extended social network comprises interaction data between each user and one or more entities;
a clustering module configured to cluster each user into one or more groups of users based on the collected user interaction data for each user, wherein each user is clustered into no more than one group of the one or more groups of users;
a monitoring module, configured to monitor, over a time period, a change in a size of each group of users at one or more increments of the time period; and
an observation module configured to generate observation information for each group of users during each of the one or more increments of the time period, wherein the observation information is based on the monitored change in size of each group of users.

10. The system of claim 9, further comprising:
a plotting module, configured to plot observation information for each group of users on a graph according to the change in size of each group of users during each increment of the time period.

11. The system of claim 9, wherein observation information for each group of users is generated in relation to a predefined condition.

12. The system of claim 11, further comprising:
associating the generated observation information with the predefined condition.

13. The system of claim 11, wherein the pre-defined condition is supplied by a third party.

14. The system of claim 9, wherein a duration of the time period is predetermined.

15. The system of claim 9, wherein a frequency of the one or more increments of the time period is predetermined.

16. A machine-readable medium comprising instructions stored therein, which when executed by the processors, cause the processors to perform operations comprising:
collecting user interaction data for one or more users in an extended social network, wherein the extended social network comprises interaction data between each of the one or more users and one or more entities;
clustering each of the one or more users into one or more groups of users based on the collected user interaction data for each user;
monitoring, over a time period, behavior trends for each group of users at one or more increments of the time period;
generating, in relation to a pre-defined condition, observation information for each group of users during each of the one or more increments of the time period, wherein the observation information is based on the monitored behavior trends for each group of users; and
associating the generated observation information with the pre-defined condition.

17. The machine-readable medium of claim 16, the operations further comprising:
plotting observation information for each group of users on a graph according to the change in size of each group of users during each increment of the time period.

18. The machine-readable medium of claim 16, wherein the pre-defined condition is supplied by a third party.

19. The machine-readable medium of claim 16, wherein a duration of the time period is predetermined.

20. The machine-retable medium of claim 16, wherein a frequency of the one or more increments of the time period is predetermined.

21. The machine-readable medium of claim 16, wherein each of the one or more users is clustered into no more than one group of the one or more groups of users.

22. The machine-readable medium of claim 16, wherein monitoring, over a time period, behavior trends for each group of users at each pre-determined increment of the time period comprises monitoring a change in a size of each group of users.

23. The machine-readable medium of claim 22, wherein generating, in relation to a pre-defined condition, observation information for each group of users during each pre-determined increment of the time period comprises generating observation information that is based on the monitored change in the size of each group of users.
